(19) United States
(12) Patent Application Publication
(10) Pub. No.: US 2026/0101163 A1
(43) Pub. Date: Apr. 9, 2026

(54) DYNAMIC EMERGENCY NOTIFICATION SYSTEM

(71) Applicant: DISH Wireless L.L.C., Englewood, CO (US)

(72) Inventor: Raghavendhra Rao, Littleton, CO (US)

(21) Appl. No.: 18/905,900

(22) Filed: Oct. 3, 2024

(51) Int. Cl. H04W 4/90; H04L 67/306; H04W 4/029; H04W 4/12

(52) U.S. Cl. CPC H04W 4/90; H04L 67/306; H04W 4/029; H04W 4/12

(57) ABSTRACT

Systems and methods for transmitting notifications to target users in response to initiation of an emergency call. An indication of an emergency call made by a user device is received. At least one target user to receive a notification regarding the emergency call is identified based on a location of the user device. A corresponding notification is generated and transmitted for each corresponding target user of the at least one target user based on the location of the user device.

### BACKGROUND

Today, people's lives are more complex than ever. Many people have multiple friends or family members, each of which have complex lives themselves. People have work, attend school, participate in sports, participate in school clubs, take music lessons, go shopping, attend concerts, and so on. All of these activities result in friends and family members being at different locations at different times. As a result, people spend a lot of effort in tracking these activities. But in doing so, people have become complacent on emergency preparedness. People are often unprepared for emergency situations and what to do when one occurs. It is with respect to these and other considerations that the embodiments described herein have been made.

### BRIEF SUMMARY

Today when there is a sudden emergency, the person having the emergency and family and friends are generally not prepared for the emergency. And because they are not prepared, they may not able to take care of their responsibilities or they may forget to do something. Embodiments described herein provide a notification to a target user(s) in response to a user device making an emergency call. An indication of the emergency call made by the user device is initially received. A location of the user device associated with the emergency call is also determined. At least one target user is identified as a recipient to receive a notification regarding the emergency call. A corresponding notification is generated for each corresponding target user of the at least one target user. The notification for some target users may be based on the location of the user device. Each corresponding notification is then transmitted to each corresponding target user. In this way, friends and family can be automatically notified of an emergency call made by another person, and each friend or family member(s) can be provided with different type(s) of information.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for dynamically notifying target users of an emergency call made by a user device or employing a proxy emergency call in accordance with embodiments described herein;

FIG. 2 is a context diagram of non-limiting embodiments of a system that provide functionality to dynamically notifying target users of an emergency call made by a user device or employing a proxy emergency call in accordance with embodiments described herein;

FIG. 3 illustrates a logical flow diagram showing one embodiment of a process for dynamically notifying target users of an emergency call made by a user device in accordance with embodiments described herein;

FIG. 4 illustrates a logical flow diagram showing one embodiment of a process for employing a user device to request a proxy emergency call in accordance with embodiments described herein;

FIG. 5 illustrates a logical flow diagram showing one embodiment of a process for employing a target user device to initiate a proxy emergency call in accordance with embodiments described herein; and

FIG. 6 shows a system diagram that describe various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

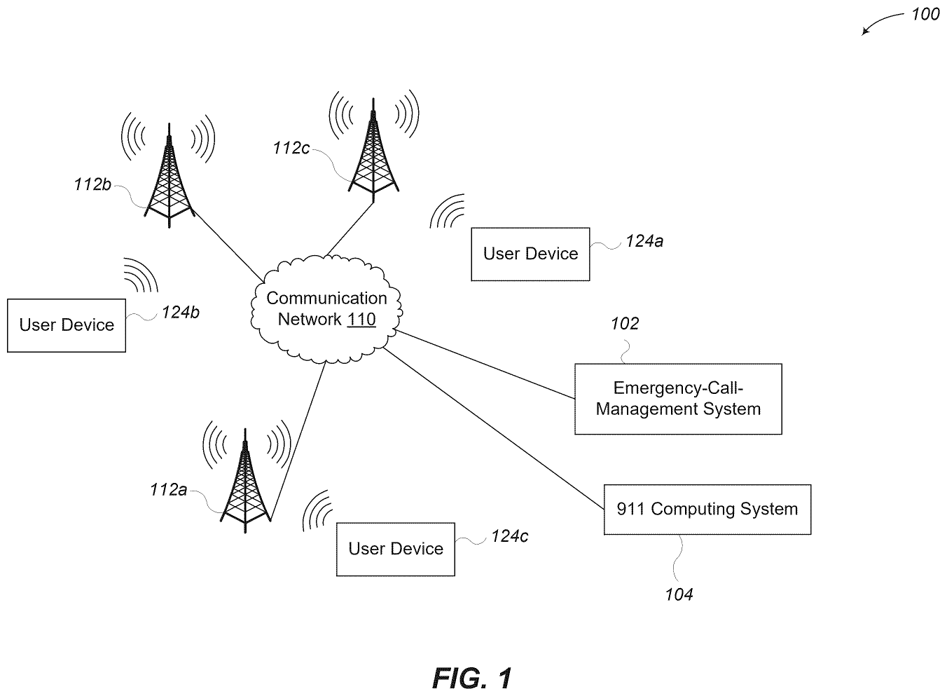

FIG. 1 illustrates a context diagram of an environment 100 for dynamically notifying target users of an emergency call made by a user device or employing a proxy emergency call in accordance with embodiments described herein. Environment 100 includes a plurality of cells 112a-112c, a plurality of user devices 124a-124c, an emergency-call-management system 102, a 911 computing system 104, and a communication network 110.

The 911 computing system 104 is configured to support a 911 dispatcher in receiving emergency calls, supporting and handling emergency calls, and dispatching emergency services. In some embodiments, the 911 computing system 104 may be part of or referred to as a PSAP (Public Safety Answering Point). Although FIG. 1 shows a single 911 computing system 104 (or PSAP), embodiments are not so limited. In some embodiments, environment 100 may include a plurality of 911 computing systems 104 (or PSAPs), where each separate 911 computing system 104 (or PSAP) supports a different geographical area or region.

The cells 112a-112c are cellular towers that together provide the hardware infrastructure of a cellular communications network, e.g., a 5G cellular communications network. The cells 112a-112c may include or be in communication with base stations, radio backhaul equipment, antennas, or other devices, which are not illustrated for case of discussion. In various embodiments, the cells 112a-112c may communicate with each other via communication network 110. The cells 112a-112c may be individually or collectively referred to as cell 112 or cells 112. Communication network 110 includes one or more wired or wireless networks, which may include a series of smaller or private connected networks that carry information between the cells 112a-112c. In some embodiments, the cells 112a-112c and the communication network 110, along with other networking components not illustrated, may collectively be referred to as a wireless network or a cellular network that supports embodiments described herein.

The user devices 124a-124c are mobile computing devices that communicate with each other or with other computing devices via a wireless network (e.g., the cellular network supported by the cells 112a-112c). User devices 124a-124c may be referred to as user devices, mobile devices, mobile computing devices, user mobile devices, user equipment, or some combination thereof, or other similar terminology. Examples of user devices 124a-124c may include, but are not limited to, mobile phones, smartphones, tablets, cellular-enabled laptop computers, RedCap devices, Internet-of-Things devices, or other computing devices that can make emergency calls or non-emergency calls via a wireless or cellular network. The user devices 124a-124c may be individually or collectively referred to as user device 124 or user devices 124.

In various embodiments, the user devices 124a-124c are configured to initiate or make emergency calls to the 911 computing system 104. The emergency call may be a voice call, a text message, RTT (real-time text), voice-over-Wi-Fi, or other type of emergency call. Briefly, a user device 124 initiates an emergency call, which is transmitted to the emergency-call-management system 102 via a cell 112. The emergency-call-management system 102 selects the proper 911 dispatcher or PSAP (i.e., the appropriate 911 computing system 104) for the emergency call. The emergency-call-management system 102 forwards the emergency call to the selected 911 dispatcher or PSAP. Although embodiments described herein discuss the user device as initiating or making an emergency call to 911, embodiments are not so limited. Rather, embodiments described herein may be employed with other types of emergency (e.g., a 112 call, or some other emergency number) or non-emergency calls (e.g., when a child reaches school or activates a smart tag on a school bus).

In some embodiments, the user devices 124a-124c may be configured to detect an emergency and automatically initiation an emergency call to the PSAP or a notification to a designated recipient, such as a hospital or care unit. Inertial sensors or biosensors on the user device may be monitored for data indicating a possible emergency or condition associated with a disease. For example, specific movement detected by the inertial sensor may indicate that the user has been in an automobile accident or is experiencing a seizure. As another example, a heartbeat monitor on the user device may detect an irregular heartbeat indicating that the user is having a heart attack. Upon detection of an emergency, the user device can automatically initiate an emergency call to the PSAP or generate a notification to a specific hospital or care unit associated with the detected emergency or specific treatment associated with the detected emergency. In some embodiments, the emergency-call-management system 102 may be configured to generate these notifications in accordance with embodiments described herein.

In some embodiments, some user devices 124 may be configured to, in response to generating or receiving an emergency alert, transmit an emergency alert command to another target user device 124 so that the target user device can initiate a proxy emergency call. In other embodiments, some user devices 124 may be configured to transmit the emergency alert to the emergency-call-management system 102, such that the emergency-call-management system 102 selects and commands another target user device to initiate the proxy emergency call. Accordingly, in various embodiments, some user devices 124 may be configured to receive the emergency alert command from the emergency-call-management system 102 or from another user device and initiate a proxy emergency call on behalf of another for user device.

The emergency-call-management system 102 is a server, computing device, cloud computing environment, or some other computing system configured to receive or intercept an emergency call (e.g., 911 calls) from user devices 124. In some embodiments, the emergency-call-management system 102 operates as an intermediate for emergency calls between the user devices 124 and the 911 dispatcher and 911 computing system 104. In other embodiments, the emergency-call-management system 102 initially receives the emergency call, but transfers or hands off the emergency call to the 911 computing system 104, such that the emergency-call-management system 102 is not an intermediary during the remainder of the emergency call.

In some embodiments, the emergency-call-management system 102 is configured to identify one or more target users to notify about an emergency call being made by a user device. The emergency-call-management system 102 generates and transmits (or broadcasts) a notification to those target users. In various embodiments, the emergency-call-management system 102 uses a location of the user device making the emergency call and an emergency profile of that user device to select which target users are to be notified and how they are to be notified. Moreover, the emergency-call-management system 102 can include the location (e.g., an accurate/actual location or an approximate location) of the user device in the notifications so that the target users can see where the emergency is happening or to receive real-time updates on the emergency.

Although embodiments are described herein as generating and transmitting notifications to target users in response to a user device initiating an emergency call, embodiments are not so limited. In some embodiments, the emergency-call-management system 102 is configured to identify one or more target users to notify about non-emergencies associated with a user device (e.g., a hiker can share its location with a central server, which can generate and send notifications as described herein to the hiker's friends or family). In other embodiments, the emergency-call-management system 102 may periodically (e.g., hourly or daily) collect data from a user device regardless of the user device making an emergency call. Examples of such data may include, but are not limited to, locations of the user device, types of calls made by the user device, recipients of calls made by the user device, etc. This collected data may be logged and analyzed (e.g., using an artificial intelligence mechanism) to detect deviations from patterns of the user. When a deviation occurs, the emergency-call-management system 102 can request more data or information from the user device or trigger the generation and transmission of notifications to one or more target users, similar to the generation and transmission of notifications in response to the user device making an emergency call.

In yet other embodiments, the emergency-call-management system 102 may receive an emergency alert, not an emergency call, from a user device 124. The emergency-call-management system 102 can identify one or more target user devices (from the user devices 124) in which to instruct to initiate a proxy emergency call on behalf of the user device that transmitted the emergency alert. As one example, a child may be in danger, but they cannot call 911 directly from their mobile phone without putting themselves in further danger. Instead, the child can initiate an emergency alert or notification on their mobile phone, which is sent to the emergency-call-management system 102. The emergency-call-management system 102 can instruct the mobile phone of the child's parent to initiate the 911 call on behalf of the child. In some embodiments, the emergency-call-management system 102 can also provide additional details to the mobile phone of the child's parent, such as the geocoded latitude/longitude location of the child's mobile phone, the associated PSAP, PSAP-relevant data (e.g., user's location, user's device, call back number, exact x/y/z location that may be useful for the PSAP to dispatch emergency help), or other information as if the child made the emergency call.

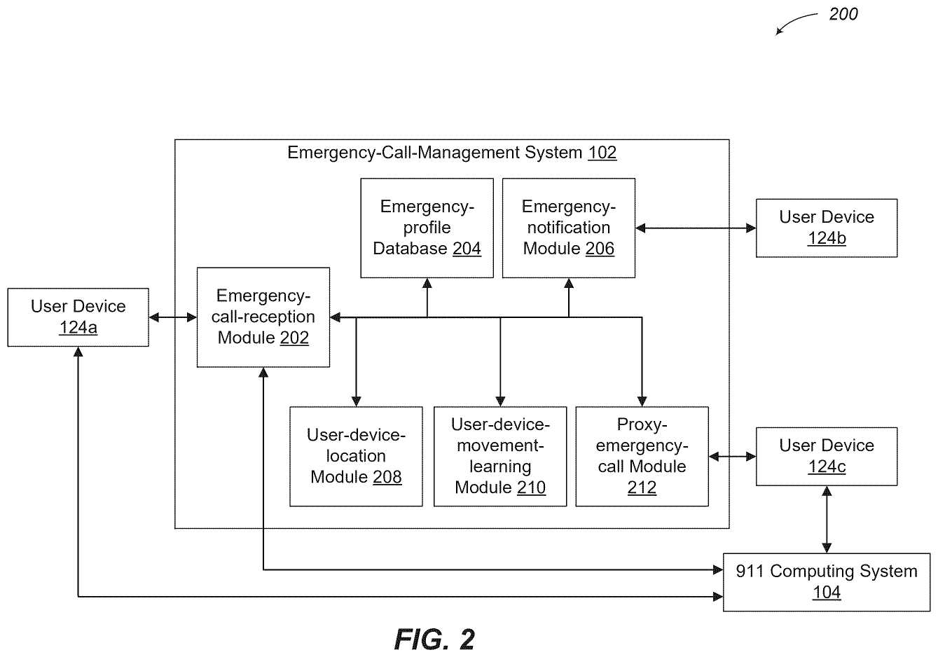

FIG. 2 is a context diagram of non-limiting embodiments of a system 200 that provides functionality to dynamically notifying target users of an emergency call made by a user device or employing a proxy emergency call in accordance with embodiments described herein. Example 200 includes an emergency-call-management system 102, a plurality of user devices 124a-124c, and a 911 computing system 104, similar to FIG. 1.

The emergency-call-management system 102 includes an emergency-call-reception module 202, an emergency-notification module 206, a user-device-location module 208, a user-device-movement-learning module 210, an emergency-profile database 204, and proxy-emergency-call module 212.

The emergency-profile database 204 is configured to store one or more emergency profiles for each of a plurality of user devices 124. Each emergency profile includes information, such as configurations and permissions, indicating who should be notified about an emergency call being made by the user device and what information is included in the notification, which may depend on the type of emergency call, the location of the user device, the day or time when the emergency call is made, etc.

In some embodiments, the emergency profile for a user device 124 may include other information that can be used to generate a personalized emergency call or notification. For example, the profile may store the user's abilities or characteristics (e.g., medical or personal information about the user or person making the emergency call, languages spoken by the user, if the user is hearing impaired or sight impaired, etc.), possible conditions or diseases that may be detected by the user device itself using software or hardware (e.g., detects stroke, irregular heartbeat, etc.), the contents of the personalized emergency call or notification, and the destination of the personalized emergency call or notification (e.g., deliver the emergency call or notification to a predetermined hospital or medical unit, which may be independent of or in addition to the call being sent to the PSAP). In some embodiments, user default permissions and options may also be stored, such as requests to the user device to turn on video, microphone, or applications during an emergency. These permissions may be selected for each emergency call or default permissions may be automatically set by rule.

In some embodiments, the emergency-profile database 204 is configured to store one or more emergency proxy profiles for each of a plurality of user devices 124. Each emergency proxy profile indicates one or more target user devices that can make proxy emergency calls on behalf of the user device associated with the emergency proxy profile. As one example, the emergency proxy profile for a child could identify the child's parent and their mobile device as the target user device that can make a proxy emergency call on behalf of the child. In some embodiments, emergency proxy profiles may also store user data regarding a user of the user device associated with the emergency proxy profile.

The emergency-call-reception module 202 is configured to receive an emergency call or an emergency alert from a user device, such as user device 124a. The emergency-call-reception module 202 provides emergency calls to the emergency-notification module 206 and emergency alerts to the proxy-emergency-call module 212. Moreover, when an emergency call is receives from user device 124a, the emergency-call-reception module 202 is configured to provide the emergency call to the 911 computing system 104. In some embodiments, the emergency-call-management system 102 may continue to act as an intermediary for the emergency call. In other embodiments, the emergency-call-management system 102 completely hands off the emergency call to the 911 computing system 104 such that user device 124a is connected directly to the 911 computing system 104 independent of the emergency-call-management system 102. In various embodiments, the emergency-call-reception module 202 may obtain the location of the user device 124a from the user-device-location module 208 and provide that location to the 911 computing system 104 along with the forwarding of the emergency call to the 911 computing system 104 (i.e., the PSAP).

In some embodiments, the emergency-call-reception module 202 may be configured to query the user device 124a for additional information or data. For example, the emergency-call-reception module 202 can request the user device 124a to turn on a camera or microphone or other sensor to collect additional data that can be forwarded to emergency services. Likewise, the emergency-call-reception module 202 can request previously-stored medical information or current biosensor information about the user (e.g., blood type, organ donor status, known diseases, etc.). The use of biosensors and previously-stored medical information can enable user devices to detect an emergency situation (e.g., erratic heartbeat) and initiate an emergency call and to enable the emergency-call-reception module 202 to augment the emergency call with additional information. This type of automatic initiation and augmentation of emergency calls can come in helpful where the user of the user device cannot speak due to a medical condition (e.g., a heart attack) that is occurring. As another example, the emergency-call-reception module 202 may be configured to turn on a camera or microphone or other sensor that is near, but not on the user device.

The user-device-location module 208 is configured to determine a location of the user device 124a that is making an emergency call or sending an emergency alert. In some embodiments, the user-device-location module 208 extracts the location directly from the emergency call or the emergency alert. In other embodiments, the user-device-location module 208 queries the user device 124a for its location upon receipt of the emergency call or emergency alert. The user-device-location module 208 provides the location of the user device 124a to the emergency-notification module 206, the proxy-emergency-call module 212, or the emergency-call-reception module 202. In some other embodiments, the user-device-location module 208 may track or periodically obtain or query the user device 124a for its location. The user-device-location module 208 can provide the tracked location to the user-device-movement-learning module 210.

The emergency-notification module 206 is configured to access the emergency-profile database 204 to obtain an emergency profile for the user device 124a and to obtain a location of the user device 124a from the user-device-location module 208. The emergency-call-reception module 202 uses the emergency profile and the location of the user device 124a to identify one or more target users that are to receive a notification about the emergency call being made by the user device 124a. The emergency-call-reception module 202 generates and transmits the notifications to one or more target user devices 124b of the identified target users.

The proxy-emergency-call module 212 is configured to access the emergency-profile database 204 to obtain an emergency proxy profile for the user device 124a and to obtain a location of the user device 124a from the user-device-location module 208. The proxy-emergency-call module 212 uses the emergency proxy profile and the location of the user device 124a to identify one or more target users that are to be instructed to initiate a proxy emergency call on behalf of the user device 124a. The proxy-emergency-call module 212 generates and transmits the emergency alert command to target user device 124c, which makes the proxy emergency call to the 911 computing system 104 on behalf of the user device 124a.

The user-device-movement-learning module 210 is configured to employ one or more trained artificial intelligence model or mechanisms (e.g., trained using historical location data for the user device or a plurality of separate user devices) using the tracked location data from the user-device-location module 208 to learn movement trends, habits, or behaviors of the user device 124a. The user-device-movement-learning module 210 may also be configured to determine if the user device 124a deviates from those learned movement trends, habits, or behaviors; and if so, instruct the emergency-notification module 206 to generate and transmit a notification to another user device 124b indicating that the user device 124a has deviated from its movement habits or behaviors. In this way, the emergency-call-management system 102 may be able to identify if a user of the user device 124a has been kidnapped, is running away, wondering, or otherwise experiencing suspicious movement, and in response notify someone else regarding the suspicious movement. In some embodiments, the emergency-call-management system 102 can request additional information from sensors on the user device 124a or from sensors on other devices (e.g., a store camera positioned near the last known location of the user device 124a) if suspicious movement is detected. The emergency-call-management system 102 can also utilize crowdsourced metadata (e.g., weather conditions, shooting detection system alerts, resident burglary calls, national emergency alerts, other information from internet-of-things devices, information from other human carried or implanted devices, internet of bodies, etc.) to further correlate user behaviors with suspicious movements. In some other embodiments, the emergency-call-management system 102 can interpret alerts or information from various systems as emergency calls and automatically transmit notifications to other systems based on those alerts or information. For example, a microphone at a known location may capture an audio signal of gun shots. The emergency-call-management system 102 can analyze the audio signal and identify the presence of gun shots. In response, the emergency-call-management system 102 can send one or more notifications with the location of the microphone to a city emergency monitoring system or nearest PSAP in proximity to the gun shot. These notifications can enables the city or PSAP to dispatch resources to the location of the gun shots to provide medical assistance or to look for the shooter.

Although the emergency-call-reception module 202, the emergency-notification module 206, the user-device-location module 208, the user-device-movement-learning module 210, and the proxy-emergency-call module 212 are illustrated as separate modules, embodiments are not so limited. Rather one module or a plurality of modules may be employed to perform the functionality of the emergency-call-reception module 202, the emergency-notification module 206, the user-device-location module 208, the user-device-movement-learning module 210, and the proxy-emergency-call module 212. These modules may be software, hardware, or some combination thereof that together perform the functionality described herein. Moreover, one or more of these modules may be optional and may not be included depending on the functionality implemented by the emergency-call-management system 102.

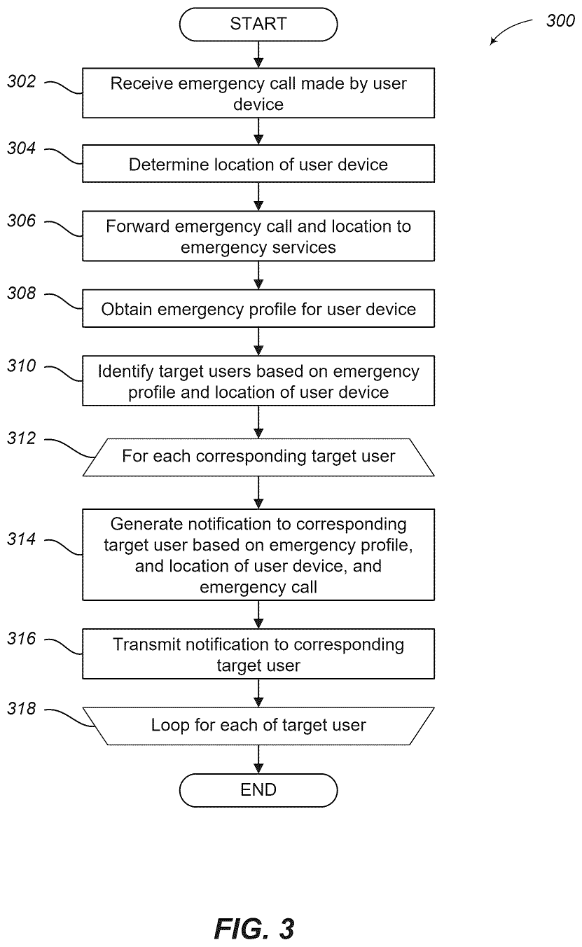

FIG. 3 illustrates a logical flow diagram showing one embodiment of a process 300 for dynamically notifying target users of an emergency call made by a user device in accordance with embodiments described herein. In at least one of various embodiments, process 300 may be implemented by, or executed via circuitry on, one or more computing devices, such as emergency-call-management system 102 or user devices 124 in FIGS. 1 and 2. As discussed herein, in some embodiments, the emergency-call-management system 102 may be an intermediary device that initially receives the emergency call from a user device via a cell of a wireless network prior to the emergency call being forwarded to a 911 dispatcher or PSAP. In other embodiments, the emergency-call-management system 102 may intercept or tap into the emergency call, but may not be part of the forwarding of the emergency call to a 911 dispatcher or PSAP.

Process 300 begins, after a start block, at block 302, where an emergency call or indication of an emergency call made by a user device is received. In some embodiments, a user of the user device may activate, trigger, or initiate the emergency call via the user device, such as by dialing “911,” selecting or activating an “SOS” emergency action, etc. In other embodiments, an application or process on the user device may initiate the emergency call, such as an application that detects if the user is in a car accident and automatically calls 911. Emergency calls, also referred to as 911 calls or e911 calls, are phone calls or messages, or other emergency communications (e.g., voice calls, RTT, text messages, voice-over-Wi-Fi, etc.), made from a user device to a 911 dispatcher. Accordingly, the emergency call is received after it is initiated by the user device.

Process 300 proceeds, after block 302, to block 304, where a location of the user device is determined. In various embodiments, the emergency call itself may include a location of the user device. In other embodiments, the user device may be queried for its location. In at least one embodiment, the location may be obtained from a Mobile Terminating Location Request (MT-LR). The location may include horizontal location data (x/y-axis) and vertical location data (z-axis) (e.g., a longitude, latitude, and elevation). In some embodiments, the location data may also include horizontal location uncertainty data and vertical location uncertainty data, along with the associated confidence.

Process 300 continues, after block 304, at block 306, where the emergency call and the location of the user device are forwarded to emergency services. In some embodiments, the emergency-call-management system 102 may select the appropriate 911 dispatcher or PSAP for the emergency call based on the location of the user device, or the cell that received the emergency call from the user device. Once the 911 dispatcher or PSAP is selected, the emergency-call-management system 102 forwards or otherwise hands off the emergency call to the 911 dispatcher or PSAP.

Process 300 proceeds, after block 306, to block 308, where an emergency profile is obtained for the user device. The emergency-call-management system 102 may store profiles for each of a plurality of user devices in a database. The database is then queried or accessed to obtain the corresponding emergency profile for the user device.

The emergency profile includes information, configurations, and permissions indicating who (i.e., target users) should be notified about an emergency call being made by the user device and what information is included in the notification, which may depend on the type of emergency call (e.g., fire emergency, robbery emergency, car accident, etc.), the location of the user device, the day or time when the emergency call is made, how the notification is transmitted (e.g., text, voice call, email, etc.), etc. The emergency profile may also indicate how the target user receives the notification (e.g., a particular alert sound that is different from a normal text or notification). In various embodiments, users may access a menu to configured, set, and define the information in their emergency profile.

Table 1 illustrates one example emergency profile for a particular user or a particular user device. In this example, assume the user device is used by a child named “Walter,” who has a father named “Karl” and a sister named “Heidi.” The notifications shown in Table 1 are triggered upon the user device making an emergency call, such that an emergency-call-management system 102 can select, generate, and transmit the appropriate notifications (some of which may include the location of the user device) to one or more target users. In some embodiments, the user may set, define, or configure the notifications via a graphical user interface. In other embodiments, the user may pick or configure the notifications upon initiation of an emergency. In yet other embodiments, the notifications may pre-set or predefined or generic notifications, such as a “your child reached school,” or “hiker is safe,” or “I am ok” (which may be periodic notifications from a child to a parent.

TABLE 1

| Location of Walter's | | | |
|---|---|---|---|
| user device when | Who to | How to | |
| emergency call is made | Notify | Notify | Content of Notification |
| Anywhere | Karl | Text message | “Walter is having an emergency” + |
| | | | Walter's location |
| Anywhere on a weekday | Karl's | Email | “Karl is having a family emergency; he |
| | Employer | | may not make it to work today” |
| Anywhere on a weekday | Walter's | Voice | “Please pick up Heidi from School |
| | Grandfather | message | today” |
| At Home | Neighbor | Text message | “Walter is having an emergency at |
| | | | home, please help” |
| Not at Home on Monday | Neighbor | Text message | “Karl has an emergency. Can you please |
| | | | set out Karl's trash can tonight?” |
| At School on a weekday | School | Email | “One of your students, Walter, just |
| | emergency | | made an emergency call from campus” + |
| | contact | | Walter's location |

In this example, if Walter makes an emergency call from school on Monday, then multiple notifications will be automatically transmitted, including: 1) a text message to Karl that says “Walter is having an emergency,” which will also include the location of Walter's user device; 2) an email to Karl's Employer that says “Karl is having a family emergency; he may not make it to work today;” 3) a previously recorded voice message Walter's Grandfather that says “Please pick up Heidi from School today; 4) a text message to Karl's neighbor that says “Can you please set out Karl's trash can tonight?”; and 5) an email to a school emergency contact that says “One of your students, Walter, just made an emergency call from campus,” which will also include the location of Walter's user device. Conversely, if Walter makes an emergency call on a Saturday from an interstate highway, then only a single notification will be automatically transmitted: a text message to Karl that says “Walter is having an emergency,” which will also include the location of Walter's user device.

The information illustrated in Table 1 is not limiting and other types of information may also be used. For example, the type of emergency call may be used. For example, an emergency call about a car accident may trigger the automatic transmission of a first set of one or more notifications, but an emergency call about a house file may trigger the automatic transmission of a second set of one or more notifications, which may include the same or different notifications as the first set. In this way, different people can be notified about different emergency situations associated with a particular user or a particular user device. Likewise, different people can receive different information about different emergency situations associated with a particular user or a particular user device (e.g., some people may receive the location of the user device that initiates the emergency call, where other people may not).

In yet other embodiments, a user can specify a hospital, company, or facility as the identified target user that is to receive a notification in response to an emergency call. For example, if a child is prone to having seizures and those seizures can be detected by an application on the child's user device (e.g., by monitoring inertial sensors on the user device), then the hospital can be directly notified in response to the application detecting a seizure. Sending notifications directly to the hospital in response to and in parallel with the emergency call to the PSAP can enable the hospital to prepare or deploy special medical units, which can save time by not waiting for a PSAP transfer. In some embodiments, the emergency call itself may also be forwarded to the hospital along with the PSAP, creating a three-way call between the caller, PSAP, and hospital.

Process 300 continues, after block 308, at block 310, where one or more target users are identified based on the emergency profile and the location of the user device. In various embodiments, the emergency profile of the user device is queried using the location of user device, along with other information associated with the emergency call, to identify one or more target users in accordance with the configurations and permissions of the emergency profile. In some embodiments, the target users may be friends, family, distant relatives, neighbors, employers, educators, hospitals, emergency services (e.g., PSAP), health clinics, or other people or entities in which the user designates as target users for notifications.

In example Table 1, if the emergency call for Walter is made from school on Monday, then Karl, Karl's Employer, Karl's neighbor, and a school emergency contact are identified as the target users. Conversely, if the emergency call is made on a Saturday from an interstate highway, then Karl is identified as the target user.

Process 300 proceeds, after block 310, to block 312, where each corresponding target user is selected from the identified target users to be processed.

For each corresponding target user, process 300 continues, after block 312, at block 314, where a notification is generated for the corresponding target user. In various embodiments, the emergency profile of the user device is queried using the corresponding target user, along with other information associated with the emergency call (e.g., the location of user device), to obtain the information used to generate the notification for the corresponding target user in accordance with the configurations and permissions of the emergency profile. In various embodiments, different identified target users may received different granularities of location data. For example, a parent of the user of the user device may receive GPS location data, where as a friend of the user may receive the name of the closest neighborhood.

In example Table 1, if the emergency call for Walter is made from school on Monday and Karl is the corresponding target user, then a text message to Karl is generated that says “Walter is having an emergency” and it includes the location of Walter's user device. Similarly, if the emergency call for Walter is made on a Saturday from an interstate highway and Karl is the corresponding target user, then a text message to Karl is generated that says “Walter is having an emergency” and it includes the location of Walter's user device.

The notification may also include other user data or metadata associated with the user or the user device. This data may include, but are not limited to, an identity of the user/person making the emergency call (e.g., using voice recognition, fingerprints, etc.); date and time of the emergency call; type of emergency call (e.g., voice, RTT, text, voice-over-Wi-Fi); type of wireless network that received the emergency call (e.g., cellular network, satellite network, WiFi network, etc.); medical or personal information about the user/person making the emergency call (e.g., user's name, age, gender, medical history, current medications, allergies, disabilities, blood type, photos of the user, languages spoken by the user (e.g., the user does not know English or can only speak Spanish or other language), or hearing impaired, or sight impaired), carrier supporting the emergency call; approximate or accurate location; speed and velocity of emergency call and age of location (e.g., how much time has passed since the last known location of the user device was obtained); address nearest to the location of the emergency call, registered location (e.g., registered address associated with a WiFi network through which the emergency call was made); general area in which the emergency call was made (e.g., if emergency call was made inside or outside of a building, or the approximate floor of the building); reverse geocoded location (x/y and z) of the user device at the time of the emergency call (e.g., country, city, street, house number and floor number, building map/floor plan, school plan); a map of the location of the user device; whether the user device is stationary or moving during the emergency call; call history of the user device; images or video captured by a camera on the user device prior to or at the time of the emergency call; dangerous or hazardous areas near the location of the user device (e.g., known drug locations, jails, bars, etc.); nearest fire station or hospital or medical facility; the user's vitals captured by biosensors associated with the user device; audio captured prior to the emergency call; battery percentage of the user device; or other information or data that can be useful to target users, or platforms that may crowdsource this information and use artificial intelligence mechanisms to make intelligent determinations, or emergency services. This other user data may be collected from user devices in response to an emergency call being made, or collected at specific times or on a periodic basis (e.g., hourly or daily). By collecting this other user data more frequently, the notifications can be augmented with this other user data when an emergency call is later made.

In some embodiments, the notification may be a personalized message that was previously recorded, generated, or prepared by the user. This notification can then be automatically provided to the target user (e.g., to the PSAP), as described herein. Personalized messages can be text, video, or audio. For example, if specific movement indicating that the user is having a seizure is detected by an inertial sensor on the user device of the user, the personalized message may be an audio recording by the user saying that the user has a history of seizures and the medication that the user is currently taking. In accordance with embodiments described herein, this notification, along with the user's location, can be provided to the PSAP so that the PSAP can dispatch the appropriate emergency services. Without this personalized message, the PSAP may receive an emergency call, but not additional information, as the user may be unable to communicate with the PSAP dispatcher.

Process 300 continues, after block 314, to block 316, where the notification is transmitted to the corresponding target user. In some embodiments, the emergency profile of the user device is queried for information on how to transmit the notification to the corresponding target user, such as a mobile phone number, an email address, etc.

Process 300 proceeds, after block 316, to block 318, which loops to block 312 to process each corresponding target user to generate and transmit a notification to that corresponding target user.

After block 318, process 300 terminates or otherwise returns to a calling process to perform other actions.

Although process 300 is illustrated as being implements by an emergency-call-management system 102, embodiments are not so limited. In some embodiments, process 300 may be implemented by, or executed via circuitry on, a user device 124 in FIG. 1. In this way, the user device can determine that an emergency call is being made by the user device, determine a location of the user device, forward or transmit the emergency call and location to emergency services (e.g., transmitting the emergency call to a cell, which is processed and forwarded to the appropriate 911 dispatcher or PSAP), obtain an emergency profile, and generate and transmit notifications to one or more target users based on the emergency profile and the location of the user device.

Although FIG. 3 is described as sending one or more notification messages in response to receiving the emergency call, embodiments are not so limited. In some embodiments, the emergency profile may indicate that one or more target users are to receive additional follow-up notifications that provide updated information on the emergency call over time. These update notifications may indicate when emergency services arrive, location tracking information as the user is being transported to a hospital, directions to the destination hospital, information about the hospital, or provide other real-time emergency update information.

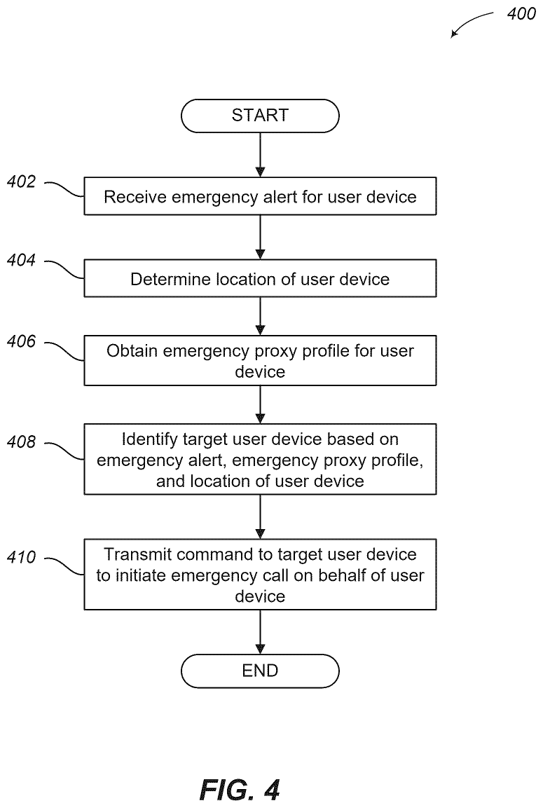

FIG. 4 illustrates a logical flow diagram showing one embodiment of a process 400 for employing a user device to request a proxy emergency call in accordance with embodiments described herein. In at least one of various embodiments, process 400 may be implemented by, or executed via circuitry, on one or more computing devices, such as emergency-call-management system 102 in FIGS. 1 and 2. In some embodiments, process 400 may be implemented by, or executed via circuitry on, a user device 124a in FIG. 2.

Process 400 begins, after a start block, at block 402, where an emergency alert is received for a user device. In some embodiments, a user of the user device may activate, trigger, or initiate the emergency alert (e.g., as a panic button or user-specified key combination) via the user device, such as by selecting or activating an “SOS” emergency action. In other embodiments, an application or process on the user device may initiate the emergency alert, such as an application that processes sounds detected by a microphone on the user device to determine if the user is being held hostage. The emergency alert is an action indicating that an emergency may be occurring, but it is not an emergency call itself. Rather, the emergency alert may be referred to as a declaration notice, notification, announcement, or broadcast of an emergency, but the emergency alert itself is not forwarded to emergency services.

In some situations, the emergency alert may be initiated because the user of the user device does not want to inform an assailant that they are trying to get ahold of emergency services. In other situations, the emergency alert may be initiated because the user device does not have a connection with a cell of the wireless network (possibly because the user device is out of range of a cell or there is an obstruction preventing the user device from obtaining a connection with a cell).

Process 400 proceeds, after block 402, to block 404, where a location of the user device is determined. Similar to block 304 in FIG. 3, the emergency alert itself may include a location of the user device. In other embodiments, the user device may be queried for its location.

Process 400 continues, after block 404, at block 406, where an emergency proxy profile is obtained for the user device. In some embodiments, the user device may store the emergency proxy profile, which may identify one or more target user devices that can make proxy emergency calls on behalf of the user device. In some embodiments, the emergency proxy profile may indicate which target user devices to use for proxy emergency calls when the user devices is in different locations. In various embodiments, different target user devices may be used for different types of emergencies.

Process 400 proceeds, after block 406, to block 408, where a target user device is identified based on the emergency alert, the emergency proxy profile, and the location of the user device. In various embodiments, the emergency proxy profile is queried for the target user device based on the location of the user device and the type of emergency.

Process 400 continues, after block 408, at block 410, where a command, or emergency alert command, is transmitted to the target user device, which causes the target user device to initiate a proxy emergency call on behalf of the user device. The command instructs the target user device to make an emergency call to emergency services. In some embodiments, the command may include the location of the user device so that the emergency call made by the target user device includes the location of the user device.

In various embodiments, the command may also include user data regarding the user of the user device. This information may include the user's name, age, gender, medical history, current medications, allergies, disabilities, blood type, photos of the user, languages spoken by the user (e.g., the user does not know English or can only speak Spanish or other language), or hearing impaired, or sight impaired (e.g., uses RTT), or other information that may be pertinent to provide emergency services during an emergency. In this way, the command can be used to generate a personalized emergency call on behalf of the user (e.g., as a pre-recorded voice message).

In some embodiments, the command may also be routed directly to a hospital or medical facility in parallel to an emergency call being routed to a PSAP. For example, if the emergency can be known apriori or identified from a known condition or detected by an application on the user device, then the command can be a personalized message to the hospital or medical facility.

After block 410, process 400 terminates or otherwise returns to a calling process to perform other actions.

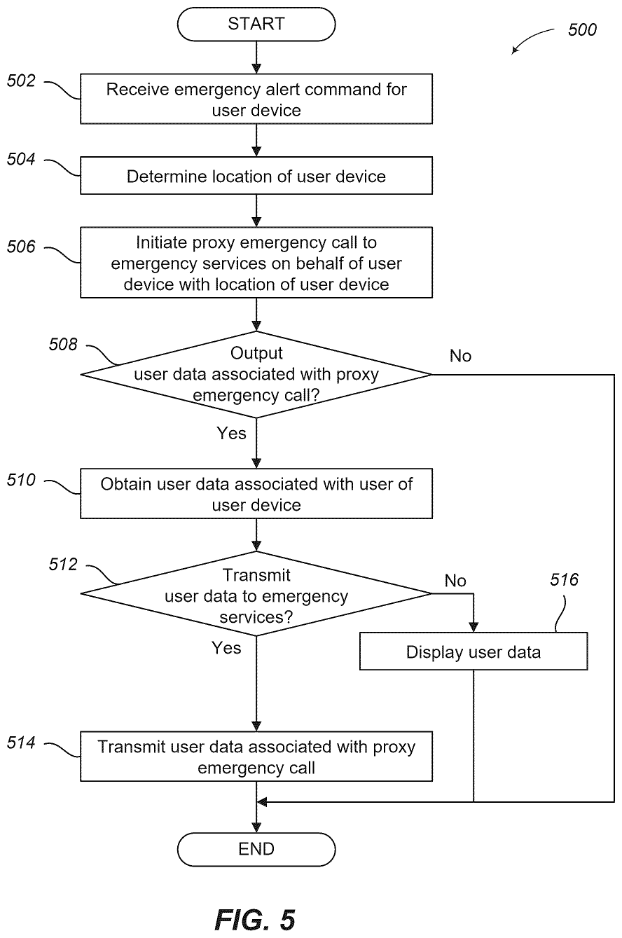

FIG. 5 illustrates a logical flow diagram showing one embodiment of a process 500 for employing a target user device to initiate a proxy emergency call in accordance with embodiments described herein. In at least one of various embodiments, process 500 may be implemented by or executed via circuitry or on one or more computing devices, such as user device 124b in FIG. 2. The user device performing process 500 may be referred to the target user device, as selected in FIG. 4.

Process 500 begins, after a start block, at block 502, where an emergency alert command is received for a user device, which is remote from the target user device performing process 500. In various embodiments, the emergency alert command is the command transmitted at block 410 in FIG. 4.

Process 500 proceeds, after block 502, to block 504, where a location of the user device is determined. In some embodiments, the emergency alert command includes the location of the user device. In other embodiments, the user device may be queried for the location of the user device.

Process 500 continues, after block 504, at block 506, where a proxy emergency call to emergency services is initiated on behalf of the user device. The proxy emergency call is automatically triggered when the target user device receives the emergency alert command from the user device. In some embodiments, the target user device can automatically dial “911” or automatically activate an “SOS” emergency action. In other embodiments, an application or process on the target user device may automatically initiate the proxy emergency call. The proxy emergency call is an emergency call, also referred to as 911 call or e911 call, which may be a voice call, text message, real-time text, voice-over-Wi-Fi, video call, or some other emergency communication, made from the target user device to a 911 dispatcher.

In some embodiments, the proxy emergency call is made with the location of the user device. In this way, a 911 dispatcher receives the emergency call as if the user device itself was making the emergency call, even though it is being made by the target user device. In other embodiments, the proxy emergency call is made with the location of the target user device. The location of the user device can then be forwarded, with the initiation of the proxy emergency call or at a later time, to the emergency services.

Process 500 proceeds, after block 506, to decision block 508, where a determination is made whether user data associated with the proxy emergency call is to be output.

In many emergency situations, the 911 dispatcher may ask for additional information regarding the caller or the injured, such as name, age, gender, medical history, etc. Because the target user device is making the proxy emergency call on behalf of the user device, the user of the target user device may not be able to answer the 911 dispatcher's questions. Accordingly, the target user device may be enabled to display user data about the user of the user device so that the user of the target user device can answer the 911 dispatcher's questions or the target user device may automatically forward such user data to the emergency services along with the proxy emergency call.

In some embodiments, the emergency alert command may include a flag indicating that the user data is to be output. In other embodiments, the target user device may have been preset to output user data when making a proxy emergency call for the user of the user device. This preset setting may be a global setting for all proxy emergency calls or it may be individually set for different users. If user data is to be output, process 500 flows to block 510; otherwise, process 500 terminates or returns to a calling process to perform other actions.

At block 510, user data associated with the user of the user device is obtained. In some embodiments, the emergency alert command may include such user data. In other embodiments, the target user device may have previously stored such user data.

Process 500 proceeds, after block 510, to decision block 512, where a determination is made whether to transmit that user data to the emergency services. In various embodiments, the user of the target user device may select whether the user data is transmitted to the emergency services or if it is displayed on the target user device. If the user data is to be transmitted to the emergency services, then process 500 flows to block 514; otherwise, process 500 flows to block 516.

At block 514, the user data is transmitted to the emergency services as part of the proxy emergency call. After block 514, process 500 terminates or otherwise returns to a calling process to perform other actions.

If, at decision block 512, the user data is not to be transmitted to the emergency services, and is instead to be displayed to a user of the target user device, then process 500 flows from decision block 512 to block 516. At block 516, the user data is displayed to the user of the target user device. In this way, the user of the target user device can read the user data and relay such information to the 911 dispatcher upon request from the 911 dispatcher. After block 516, process 500 terminates or otherwise returns to a calling process to perform other actions.

Although not illustrated, the proxy emergency call may last for multiple seconds or minutes until the call is terminated. Furthermore, although not illustrated, a plurality of user devices may daisy chain multiple emergency alerts from one to the next until a user device finally makes the proxy emergency call. For example, if a target user device receives an emergency alert command, but does not have access to a cellular network to make the proxy emergency call, then that target user device can transmit another emergency alert to yet another target user device, which can attempt to make the proxy emergency call. If this other target user device does not have access to a cellular network to make the proxy emergency call, then it can send yet another emergency alert. These emergency alerts can continue to be sent from one target user device to another until a target user device can make the proxy emergency call on behalf of the original user device that initiated the emergency alert.

Moreover, although FIGS. 3, 4, and 5, illustrates the blocks, steps, and acts being performed in a specific order, embodiments are not so limited. Rather, one or more of the various blocks, steps, or acts may be performed in parallel or in a logical order other than what is illustrated.

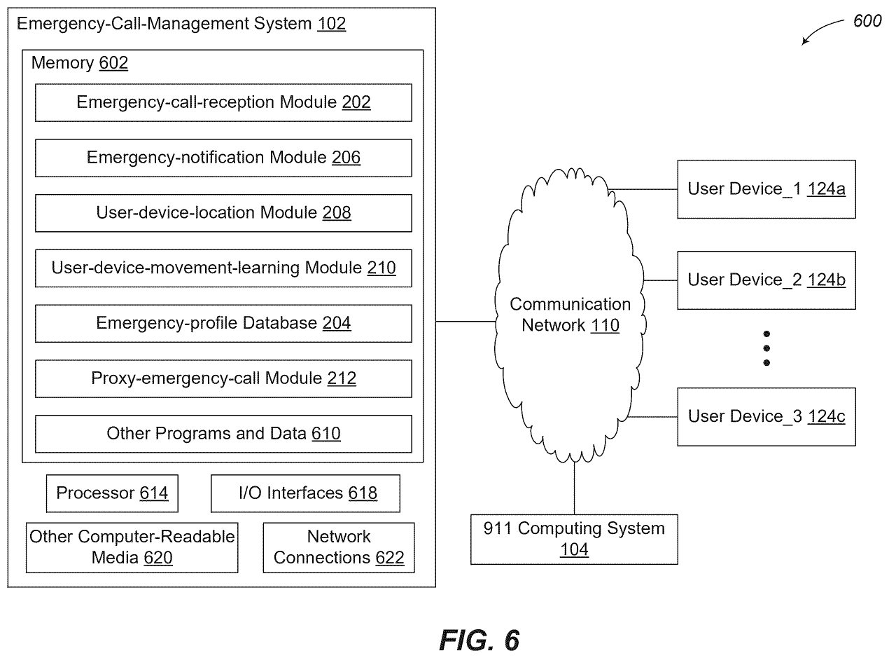

FIG. 6 shows a system diagram that describe various implementations of computing systems 600 for implementing embodiments described herein. Systems 600 include an emergency-call-management system 102, a 911 computing system 104, and user devices 124a-124c.

The emergency-call-management system 102 is a computing system or environment that, in some embodiments, generates transmits notifications to target user devices in response to a user device initiating an emergency call, or, in other embodiments, initiates a proxy emergency call in response to receiving an emergency alert from a user device, as described herein. One or more special-purpose computing systems may be used to implement the user-device-location-compliance computing device 102. Accordingly, various embodiments described herein may be implemented in software, hardware, firmware, or in some combination thereof. The emergency-call-management system 102 includes memory 602, processor 614, I/O interfaces 618, other computer-readable media 620, and network connections 622.

Processor 614 includes one or more processors, one or more processing units, programmable logic, circuitry, or one or more other computing components that are configured to perform embodiments described herein or to execute computer instructions to perform embodiments described herein. In some embodiments, a processor system may include a single processor 614 that operates individually to perform actions. In other embodiments, a processor system may include a plurality of processors 614 that operate to collectively perform actions, such that one or more processors 614 may operate to perform some, but not all, of such actions. Reference herein to “a processor system” refers to one or more processors 614 that individually or collectively perform actions. And reference herein to “the processor system” refers to 1) a subset or all of the one or more processors 614 comprised by “a processor system” and 2) any combination of the one or more processors 614 comprised by “a processor system” and one or more other processors 614.

Memory 602 may include one or more various types of non-volatile and/or volatile storage technologies. Examples of memory 602 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 602 may be utilized to store information, including computer-readable instructions that are utilized by a processor system to perform actions, including embodiments described herein.

Memory 602 may have stored thereon emergency-call-reception module 202, emergency-notification module 206, user-device-location module 208, user-device-movement-learning module 210, emergency-profile database 204, and proxy-emergency-call module 212, which are described in more detail herein. Memory 602 may also store other programs and data 610 (e.g., operating systems, user device data, etc.).

Network connections 622 are configured to communicate with other computing devices, such as 911 computing system 104 or user devices 124a-124c. In various embodiments, the network connections 622 include transmitters and receivers (not illustrated) to send and receive data as described herein. I/O interfaces 618 may include one or more data input or output interfaces, video or display interfaces, or other input/output interfaces. Other computer-readable media 620 may include other types of stationary or removable computer-readable media, such as removable flash drives, external hard drives, or the like.

The user devices 124a-124c may include computing components similar to emergency-call-management system 102, but are not shown in FIG. 6 for ease of discussion. As described herein, the computing components of the user devices 124a-124c cause the user devices to communicate with the emergency-call-management system 102 to have notifications automatically transmitted to other target user device in response to the user device initiating or making an emergency call. In some embodiments, the computing components of the user devices 124a-124c cause the user devise to send emergency alerts to other target user devices, so that those target user devices can initiate proxy emergency calls on behalf of the user device that sent the emergency alert. As such, in some embodiments, the computing components of user devices 124a-124c cause the user devise to receive emergency alerts from other user devices and to make proxy emergency calls. Similarly, the 911 computing system 104 may include computing components similar to emergency-call-management system 102, but are not shown in FIG. 6 for ease of discussion.

The following is a summarization of the original claims as filed.

A method may be summarized as comprising: receiving an indication of an emergency associated with a user device; identifying at least one target user to receive a notification regarding the emergency; generating a corresponding notification for each corresponding target user of the at least one target user; and transmitting the corresponding notification to each corresponding target user.

The method may identify the at least one target user by: obtaining an emergency profile for the user device; and identifying the at least one target user based on the emergency profile and a location of the user device.

The method may generate the corresponding notification for each corresponding target user by: generating the corresponding notification for each corresponding target user of the at least one target user based on an emergency profile for the user device, a location of the user device, and a type of the emergency.

The method may generate the corresponding notification for each corresponding target user by: generating the corresponding notification for each corresponding target user of the at least one target user to include a location of the user device.

The method may generate the corresponding notification for each corresponding target user by: generating a notification for at least one corresponding target user of the at least one target user to include a destination in which a person associated with the emergency is being transported.

The method may transmit the corresponding notification to each corresponding target user by: transmitting a first notification to a first target user, wherein the first notification includes a first message to the first target user and a location of the user device; and transmitting a second notification to a second target user, wherein the second notification includes a second message to the second target user:

The method may include: receiving an updated location of the user device associated with the emergency; and transmitting an updated notification to at least one corresponding target user of the at least one target user.

The method may include: in response to receiving the indication of the emergency, causing a sensor on the user device to activate; receiving data from the sensor; and forwarding the data with an emergency call to emergency services.

The method may include: receiving data from the user device, wherein the data was capture prior the emergency; and forwarding the data with an emergency call to emergency services.

The method may include: receiving data from the user device, wherein the data was captured prior to the emergency; and including the data in the corresponding notification for at last one corresponding target user.

The at least one target user in the method may include at least one of: a parent of a user of the user device, an employer of the user of the user device, a supervisor of the user of the user device, a doctor of the user of the user device, or a neighbor of the parent of the user of the user device.

The method may receive the indication of the emergency made by the user device by: receiving data from the user device; employing an artificial intelligence mechanism on the data to detect an emergency associated with a user of the user device; and initiating an emergency call in response to detection of the emergency.

The method may include: receiving information from the user device; and generating the indication of the emergency from the information.

The method may transmit the corresponding notification to a corresponding target user by: transmitting the corresponding notification to an emergency computing system.

The method may generate the corresponding notification for a corresponding target user by: generating the corresponding notification from a personalized notification preset by the user.

The indication of the emergency in the method may be automatically triggered in response to detection of the emergency by the user device.

The method may include: causing a camera, microphone, or sensor associated with the user device to be turned on during the emergency.

A computing device may be summarized as comprising: a memory configured to store computer instructions; and a processor system configured to execute the computer instructions to: receive an indication of an emergency associated with a user device; determine a location of the user device during the emergency; forward an emergency call between the user device and emergency services; identify at least one target user to receive a notification regarding the emergency; generate a corresponding notification for each corresponding target user of the at least one target user based on the location of the user device; and transmit the corresponding notification to each corresponding target user.

A non-transitory computer-readable medium may be summarized as storing computer instructions that, when executed by at least one processor, cause the at least one processor to perform actions, the actions comprising: receiving an emergency call from a user device; determining a location of the user device for the emergency call; forwarding the emergency call with the location of the user device to emergency services; obtaining an emergency profile for the user device; identifying at least one target user to receive a notification regarding the emergency call based on the location of the user device and the emergency profile; generating a corresponding notification for each corresponding target user of the at least one target user based on the emergency profile; and transmitting the corresponding notification to each corresponding target user.

The various embodiments described above can be combined to provide further embodiments. These and other changes can be made to the embodiments in light of the above-detailed description. All of the U.S. patents, U.S. patent application publications, U.S. patent applications, foreign patents, foreign patent applications and non-patent publications listed in the Application Data Sheet are incorporated by reference, in their entirety. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
receiving an indication of an emergency associated with a user device;
identifying at least one target user to receive a notification regarding the emergency;
generating a corresponding notification for each corresponding target user of the at least one target user; and
transmitting the corresponding notification to each corresponding target user.

2. The method of claim 1, wherein identifying the at least one target user comprises:
obtaining an emergency profile for the user device; and
identifying at least one target user based on the emergency profile and a location of the user device.

3. The method of claim 1, wherein generating the corresponding notification for each corresponding target user comprises:
generating the corresponding notification for each corresponding target user of the at least one target user based on an emergency profile for the user device, a location of the user device, and a type of the emergency.

4. The method of claim 1, wherein generating the corresponding notification for each corresponding target user comprises:
generating the corresponding notification for each corresponding target user of the at least one target user to include a location of the user device.

5. The method of claim 1, wherein generating the corresponding notification for each corresponding target user comprises:
generating a notification for at least one corresponding target user of the at least one target user to include a destination in which a person associated with the emergency is being transported.

6. The method of claim 1, wherein transmitting the corresponding notification to each corresponding target user comprises:
transmitting a first notification to a first target user, wherein the first notification includes a first message to the first target user and a location of the user device; and
transmitting a second notification to a second target user, wherein the second notification includes a second message to the second target user.

7. The method of claim 1, further comprising:
receiving an updated location of the user device associated with the emergency; and
transmitting an updated notification to at least one corresponding target user of the at least one target user.

8. The method of claim 1, further comprising:
in response to receiving the indication of the emergency, causing a sensor on the user device to activate;
receiving data from the sensor; and
forwarding the data with an emergency call to emergency services.

9. The method of claim 1, further comprising:
receiving data from the user device, wherein the data was capture prior the emergency; and
forwarding the data with an emergency call to emergency services.

10. The method of claim 1, further comprising:
receiving data from the user device, wherein the data was captured prior to the emergency; and
including the data in the corresponding notification for at last one corresponding target user.

11. The method of claim 1, wherein the at least one target user includes at least one of: a parent of a user of the user device, an employer of the user of the user device, a supervisor of the user of the user device, a doctor of the user of the user device, or a neighbor of the parent of the user of the user device.

12. The method of claim 1, wherein receiving the indication of the emergency made by the user device comprises:
receiving data from the user device;
employing an artificial intelligence mechanism on the data to detect an emergency associated with a user of the user device; and
initiating an emergency call in response to detection of the emergency.

13. The method of claim 1, further comprising:
receiving information from the user device; and
generating the indication of the emergency from the information.

14. The method of claim 1, wherein transmitting the corresponding notification to a corresponding target user, comprises:
transmitting the corresponding notification to an emergency computing system.

15. The method of claim 1, wherein generating the corresponding notification for a corresponding target user comprises:
generating the corresponding notification from a personalized notification preset by the user.

16. The method of claim 1, wherein the indication of the emergency is automatically triggered in response to detection of the emergency by the user device.

17. The method of claim 1, further comprising:
causing a camera, microphone, or sensor associated with the user device to be turned on during the emergency.

18. The method of claim 1, wherein generating the corresponding notification comprises:
obtaining a personalized message that was previously prepared by the user for transmission to emergency services.

19. A computing device, comprising:
a memory configured to store computer instructions; and
a processor system configured to execute the computer instructions to:
receive an indication of an emergency associated with a user device;
determine a location of the user device during the emergency;
forward an emergency call between the user device and emergency services;
identify at least one target user to receive a notification regarding the emergency;
generate a corresponding notification for each corresponding target user of the at least one target user based on the location of the user device; and
transmit the corresponding notification to each corresponding target user.

20. A non-transitory computer-readable medium storing computer instructions that, when executed by at least one processor, cause the at least one processor to perform actions, the actions comprising:
receiving an emergency call from a user device;
determining a location of the user device for the emergency call;
forwarding the emergency call with the location of the user device to emergency services;
obtaining an emergency profile for the user device;
identifying at least one target user to receive a notification regarding the emergency call based on the location of the user device and the emergency profile;
generating a corresponding notification for each corresponding target user of the at least one target user based on the emergency profile; and
transmitting the corresponding notification to each corresponding target user.
